(19) United States
(12) Patent Application Publication
(10) Pub. No.: US 2025/0310640 A1
(43) Pub. Date: Oct. 2, 2025

(54) IMAGE PROCESSING APPARATUS AND METHOD, ELECTRONIC APPARATUS, AND STORAGE MEDIUM

(71) Applicant: CANON KABUSHIKI KAISHA, Tokyo (JP)

(72) Inventors: YOHEI OHASHI, Chiba (JP); HIROYO TANAKA, Kanagawa (JP)

(21) Appl. No.: 19/078,857

(22) Filed: Mar. 13, 2025

(30) Foreign Application Priority Data
Mar. 28, 2024 (JP) 2024-054632

(51) Int. Cl. H04N 23/667; H04N 23/61; H04N 23/68

(52) U.S. Cl. CPC H04N 23/667; H04N 23/61; H04N 23/684

(57) ABSTRACT

An image processing apparatus comprises: an input unit that inputs an image; a processing unit that crops a partial image of a predetermined range from the image; a control unit that controls size and position of the range; and a switching unit that switches between a plurality of modes involving processing of cropping the partial image. In a case where at least one of the size and the position of the range changes before and after the switching of the mode by the switching unit, the control unit controls to gradually change the size and/or the position of the range that changes before and after the switching of the mode.

### BACKGROUND OF THE INVENTION

### Field of the Invention

The present invention relates to an image processing apparatus and method, an electronic apparatus, and a storage medium, and especially to a technique for stabilizing a displayed image.

### Description of the Related Art

Conventionally, there are image capturing apparatuses equipped with an image stabilization apparatus and capable of stabilizing image blur caused by camera shake in moving images. In such image capturing apparatuses, image blur is reduced by performing so-called optical image stabilization or electronic image stabilization. In optical image stabilization, an image stabilization unit such as an image stabilization lens or an image sensor is moved in accordance with camera shake information detected by a camera shake detection unit so as to cancel out the camera shake. In electronic image stabilization, an area smaller than an angle of view is cropped out of a captured image by image processing so as to cancel out camera shake.

Furthermore, a subject tracking technique is also known in which a subject is detected from a captured image and the detected subject is tracked and held at a predetermined position in the angle of view by controlling a cropping position by image processing for electronic image stabilization. In this technique, at the time of starting or ending subject tracking, it is necessary to shift the position of a cropping range in the image (e.g., the center position of the cropping range) between a predetermined position (e.g., the center position) of the captured image and the target position of subject tracking.

Japanese Patent No. 4793639 proposes a method of gradually shifting a displayed image from a first angle of view to a second angle of view at a predetermined rate over a plurality of frames when the crop angle of view is changed at the start or end of electronic image stabilization, thereby reducing the sense of discomfort that accompanies the change in angle of view at the start or end of electronic image stabilization.

However, even if a cropping range in the image is gradually shifted as described in Japanese Patent No. 4793639, if the size of the cropping range in the image changes depending on whether or not subject tracking is being performed, incongruity may newly appear on the display screen at the start or end of subject tracking.

### SUMMARY OF THE INVENTION

The present invention has been made in consideration of the above situation, and upon changing modes that involves a change in the size and/or position of the cropping range in an image, the change in a displayed image is made less noticeable.

According to the present invention, provided is an image processing apparatus comprising one or more processors and/or circuitry which function as: an input unit that inputs an image; a processing unit that crops a partial image of a predetermined range from the image; a control unit that controls size and position of the range; and a switching unit that switches between a plurality of modes involving processing of cropping the partial image, wherein in a case where at least one of the size and the position of the range changes before and after the switching of the mode by the switching unit, the control unit controls to gradually change the size and/or the position of the range that changes before and after the switching of the mode.

Further, according to the present invention, provided is an image processing apparatus comprising one or more processors and/or circuitry which function as: an input unit that inputs an image; a processing unit that crops a partial image of a predetermined range from the image; a control unit that controls size and position of the range; and a switching unit that switches between a plurality of modes involving processing of cropping the partial image, wherein, in a case where the size of the range changes before and after the switching of the mode by the switching unit, the control unit changes the position of the range in a shorter time than in a case where the size of the range does not change before and after the switching of the mode.

Furthermore, according to the present invention, provided is an electronic apparatus comprising: an image processing apparatus comprising one or more processors and/or circuitry which function as: an input unit that inputs an image; a processing unit that crops a partial image of a predetermined range from the image; a control unit that controls size and position of the range; and a switching unit that switches between a plurality of modes involving processing of cropping the partial image; and an image sensor that shoots an image, wherein in a case where at least one of the size and the position of the range changes due to the switching of the modes by the switching unit, the control unit controls so that the size and/or the position of the range that changes gradually changes.

Further, according to the present invention, provided is an electronic apparatus comprising: an image processing apparatus comprising one or more processors and/or circuitry which function as: an input unit that inputs an image; a processing unit that crops a partial image of a predetermined range from the image; a control unit that controls size and position of the range; and a switching unit that switches between a plurality of modes involving processing of cropping the partial image; and an image sensor that shoots an image, wherein, in a case where the size of the range changes before and after a mode change due to the switching of the mode by the switching unit, the control unit changes the position of the range in a shorter time than in a case where the size of the range does not change before and after the mode change.

Further, according to the present invention, provided is an image processing method for cropping a partial image of a predetermined range from an input image comprising: determining whether or not switching between a plurality of modes involving processing of cropping the partial image is performed; and in a case where it is determined that the mode is switched and at least one of the size and the position of the range changes before and after the switching of the mode, gradually changing the size and/or the position of the range that changes before and after the switching of the mode.

Further, according to the present invention, provided is an image processing method for cropping a partial image of a predetermined range from an input image comprising: determining whether or not switching between a plurality of modes involving processing of cropping the partial image is performed; and in a case where it is determined that the mode is switched and the size of the range changes before and after the switching of the mode, changing the position of the range in a shorter time than in a case where the size of the range does not change before and after the switching of the mode.

Further, according to the present invention, provided is a non-transitory computer-readable storage medium, the storage medium storing a program that is executable by the computer, wherein the program includes program code for causing the computer to function as an image processing apparatus comprising: an input unit that inputs an image; a processing unit that crops a partial image of a predetermined range from the image; a control unit that controls size and position of the range; and a switching unit that switches between a plurality of modes involving processing of cropping the partial image, wherein in a case where at least one of the size and the position of the range changes before and after the switching of the mode by the switching unit, the control unit controls to gradually change the size and/or the position of the range that changes before and after the switching of the mode.

Further, according to the present invention, provided is a non-transitory computer-readable storage medium, the storage medium storing a program that is executable by the computer, wherein the program includes program code for causing the computer to function as an image processing apparatus comprising: an input unit that inputs an image; a processing unit that crops a partial image of a predetermined range from the image; a control unit that controls size and position of the range; and a switching unit that switches between a plurality of modes involving processing of cropping the partial image, wherein, in a case where the size of the range changes before and after the switching of the mode by the switching unit, the control unit changes the position of the range in a shorter time than in a case where the size of the range does not change before and after the switching of the mode.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram illustrating an example of a configuration of an image capturing apparatus according to an embodiment of the present invention.

FIG. 2 is a block diagram illustrating an example of a configuration relating to image stabilization control and subject tracking control according to a first embodiment.

FIG. 3 is a flowchart illustrating control according to the first embodiment.

FIGS. 4A and 4B are time charts illustrating an example of a tracking control amount according to the first embodiment.

FIG. 5 is a time chart illustrating a problem according to a second embodiment.

FIG. 6 is a flowchart illustrating control according to the second embodiment.

FIG. 7 is a time chart illustrating an example of a tracking control amount according to the second embodiment.

FIG. 8 is a time chart illustrating an example of a tracking control amount and a size of a cropping range according to a third embodiment.

FIG. 9 is a time chart illustrating a problem at a time of changing from a subject tracking mode to an electronic image stabilization mode.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### First Embodiment

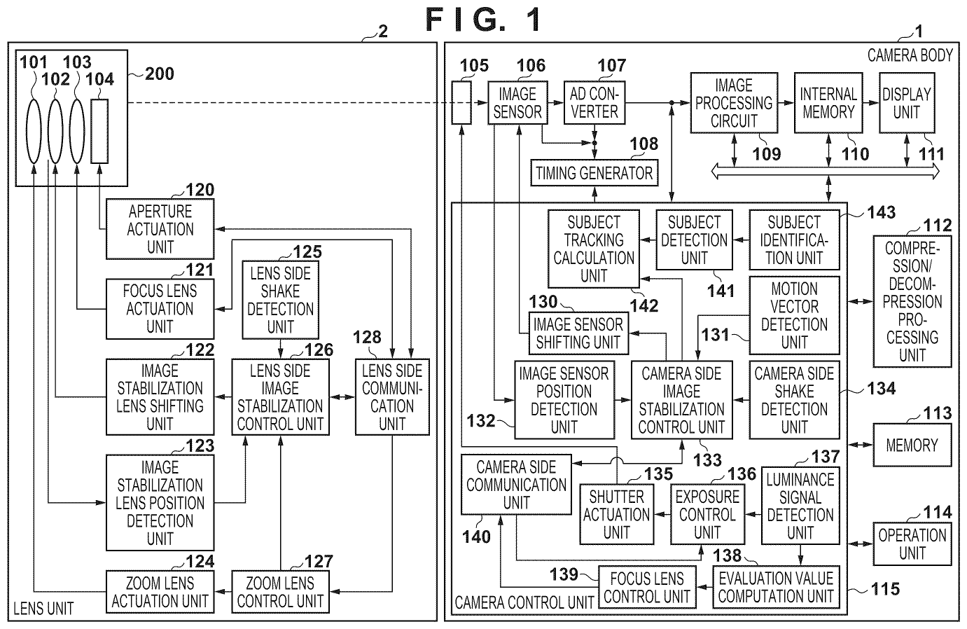

FIG. 1 is a block diagram illustrating an example of a configuration of an image capturing apparatus in this embodiment. In this embodiment, a digital camera is described as an example of the image capturing apparatus. However, the present invention is not limited to this, and may be various electronic apparatuses equipped with a camera function. For example, the image capturing apparatus according to the present invention may be a mobile communication terminal with a camera function such as a mobile phone or a smartphone, a mobile computer with a camera function, a mobile game machine with a camera function, etc.

Further, the image capturing apparatus according to this embodiment is made up of a camera body 1 and a lens unit 2 configured to be detachable from the camera body 1, but it may also be configured as an integrated unit.

A zoom lens 101 optically changes the focal length of an imaging optical system (imaging lens) 200 by moving in the optical axis direction, and changes the shooting angle of view. An image stabilization lens 102 optically corrects image blur caused by vibration of the image capturing apparatus by moving in the direction perpendicular to the optical axis. A focus lens 103 optically adjusts the focus position by moving in the optical axis direction. An aperture 104 and a shutter 105 can adjust an amount of light by opening and closing, and are used for exposure control.

Light that has passed through the imaging optical system 200 is received by an image sensor 106, which uses a CCD or CMOS sensor or the like, via the shutter 105 configured in the camera body 1 and is converted by photoelectric conversion into an electrical signal (image signal) according to the amount of light.

An AD converter 107 performs noise reduction processing, gain adjustment processing, and AD conversion processing on the image signal read out from the image sensor 106, and outputs a digital image signal.

A timing generator 108 controls the actuation timing of the image sensor 106 and the output timing of the AD converter 107 according to commands from a camera control unit 115.

An image processing circuit 109 performs pixel interpolation processing, color conversion processing, etc. on the digital image signal output from the AD converter 107, and sends the processed digital image signal (image data) to an internal memory 110. The image processing circuit 109 includes a position alignment circuit for a plurality of images captured in succession, a geometric transformation circuit for performing cylindrical coordinate transformation and distortion correction for correcting distortion caused by a lens group, a synthesis circuit for performing trimming and synthesis processing, etc. Electronic image stabilization is performed using a projective transformation circuit provided in the image processing circuit 109. Note that the operation of each circuit is well known, so detailed explanation thereof will be omitted.

The internal memory 110 stores image data, shooting information, various control programs, and so on.

A display unit 111 displays the image data held in the internal memory 110, shooting information, and so forth.

A compression/decompression processing unit 112 performs compression or decompression processing on the image data stored in the internal memory 110 according to the format of the image data.

A memory 113 stores various data such as parameters.

An operation unit 114 is a user interface that allows the user to perform various menu operations, mode switching operations, etc.

The camera control unit 115 is composed of an arithmetic unit such as a central processing unit (CPU), and executes various control programs stored in the internal memory 110 in response to user operations of the operation unit 114. The control programs include, for example, programs for performing zoom control, image stabilization control, automatic exposure control, automatic focus adjustment control, and processing for detecting the face of a subject. The camera control unit 115 will be described in detail below, and processing in each unit is realized by the CPU executing the control program stored in the internal memory 110.

A luminance signal detection unit 137 detects the luminance signal of the subject and/or the entire image based on the digital image signal obtained by converting an image signal read from the image sensor 106 by the AD converter 107, and calculates the luminance.

An exposure control unit 136 calculates an exposure value (aperture value and shutter speed) based on the luminance obtained by the luminance signal detection unit 137, and notifies an aperture actuation unit 120 and a shutter actuation unit 135 of the calculation result. The exposure control unit 136 also obtains a gain value used in gain adjustment processing in the AD converter 107, and notifies the AD converter 107 of the gain value. In this way, automatic exposure control (AE control) is performed.

In the case of a camera with interchangeable lenses, information is transmitted between the camera body 1 and the lens unit 2 via a camera side communication unit 140 and a lens side communication unit 128.

The aperture actuation unit 120 and the shutter actuation unit 135 actuate the aperture 104 and the shutter 105, respectively.

An evaluation value calculation unit 138 extracts a specific frequency component from the luminance signal obtained by the luminance signal detection unit 137, calculates a contrast evaluation value based on the extracted luminance signal of the specific frequency, and outputs it to a focus lens control unit 139.

The focus lens control unit 139 issues a command to actuate the focus lens 103 by a predetermined actuation amount over a predetermined range, while acquiring a contrast evaluation value at each focus lens position from the evaluation value calculation unit 138. As a result, a defocus amount in the contrast AF method is calculated from the focus lens position at which the curve of the changing contrast evaluation value reaches its peak, and the calculated defocus amount is notified to a focus lens actuation unit 121 via the camera side communication unit 140 and the lens side communication unit 128.

The focus lens actuation unit 121 actuates the focus lens 103 based on the notified defocus amount, thereby performing automatic focus adjustment control (AF control) to focus the light flux on the light receiving surface of the image sensor 106.

Note that although the contrast AF method is described here, a phase difference AF method may also be used. As the phase difference AF method is well known, a description thereof will be omitted.

A zoom lens control unit 127 determines an actuation amount of the zoom lens 101 in accordance with a zoom operation instruction from the operation unit 114, and a zoom lens actuation unit 124 changes the angle of view by actuating the zoom lens 101 based on the actuation amount. The determined actuation amount is also output to a lens side image stabilization control unit 126.

A camera side shake detection unit 134 is, for example, a gyro sensor, and detects shake or vibration applied to the image capturing apparatus. In this embodiment, in addition to camera side shake detection unit 134 arranged on the camera body 1 side, a lens side shake detection unit 125 composed of, for example, a gyro sensor, is also arranged on the lens unit 2 side to detect shake or vibration applied to the lens.

A motion vector detection unit 131 uses a block matching method to calculate a correlation value between the current frame image and the previous frame image for each of a plurality of blocks into which the frame image is divided. It then searches for a block of the previous frame image with the smallest correlation value and, using the deviation of the block as a reference, detects the deviation of other blocks between the frame images as a motion vector between the images.

A camera side image stabilization control unit 133 on the camera body 1 can communicate with the lens side image stabilization control unit 126 on the lens unit 2 via the camera side communication unit 140 and the lens side communication unit 128 in the imaging optical system 200. The camera side image stabilization control unit 133 in the camera body 1 calculates an image sensor shake correction amount for suppressing shake using the image sensor 106 based on a shake detection signal detected by the camera side shake detection unit 134, the lens side shake detection unit 125, or both. Then, based on the calculated shake correction amount and the position of the image sensor 106 detected by an image sensor position detection unit 132, the camera side image stabilization control unit 133 transmits a shift signal for shifting the position of the image sensor 106 to an image sensor shifting unit 130. Based on the shift signal of the image sensor received from the camera side image stabilization control unit 133, the image sensor shifting unit 130 shifts the image sensor 106 in a direction perpendicular to the optical axis.

An image stabilization lens position detection unit 123 detects the position of the image stabilization lens 102.

The lens side image stabilization control unit 126 calculates a shake correction amount for suppressing shake based on a shake detection signal detected by the lens side shake detection unit 125, the camera side shake detection unit 134, or both. Then, based on the calculated shake correction amount and the position of the image stabilization lens 102 detected by the image stabilization lens position detection unit 123, the lens side image stabilization control unit 126 transmits a shift signal for shifting the position of the image stabilization lens 102 to an image stabilization lens shifting unit 122. Based on the shift signal received from the lens side image stabilization control unit 126, the image stabilization lens shifting unit 122 shifts the image stabilization lens 102 in a direction perpendicular to the optical axis.

A subject detection unit 141 detects an image region of a subject included in an image and generates subject detection information based on the digital image signal output from the AD converter 107. The subject detection information includes information on the type of subject (e.g., person, animal, vehicle), part (e.g., eye, face, body), position, size, etc.

A subject identification unit 143 sets a specific subject within a captured image. A photographer can set an arbitrary subject as the subject to be tracked by performing a touch operation or button operation using the operation unit 114. Note that the subject to be tracked may be determined by an automatic subject setting program in the camera even if there is no operation on the operation unit 114 by the photographer.

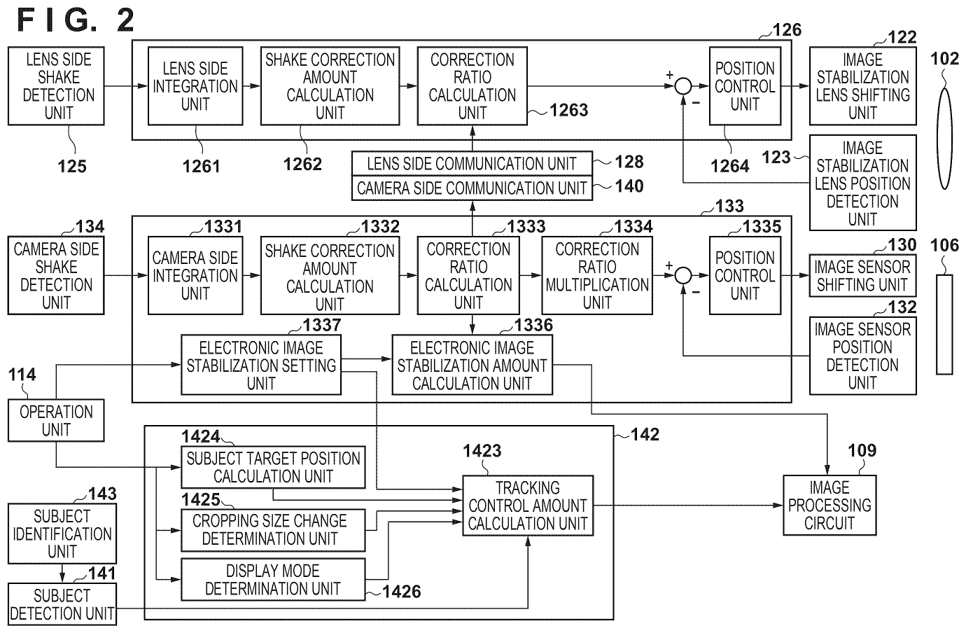

A subject tracking calculation unit 142 calculates an amount for tracking the subject, and details will be described using FIG. 2.

FIG. 2 is a block diagram illustrating an example of a configuration relating to image stabilization control and subject tracking control according to the first embodiment.

First, the camera side image stabilization control unit 133 in the camera body 1 will be described. Note that, to simplify the explanation, the shake detection signal detected by the lens side shake detection unit 125 will not be used in the explanation.

A camera side integration unit 1331 integrates an angular velocity of shake detected by the camera side shake detection unit 134 to convert it into an angle of shake. Here, the camera side integration unit 1331 uses an integral low pass filter (LPF).

A shake correction amount calculation unit 1332 calculates a shake correction amount that cancels the angle of shake, taking into consideration the frequency band of the angle of shake and the movable range of the image sensor 106. Specifically, the shake correction amount calculation unit 1332 calculates the shake correction amount by multiplying a gain related to the zoom magnification and the subject distance to the angle of shake.

A correction ratio calculation unit 1333 calculates the correction ratio of the shake correction amount that the camera body 1 side takes in a case where the sum of the shake correction amounts taken on the camera body 1 side and the lens unit 2 side is 100%. In this embodiment, the correction ratio is determined based on the movable ranges of the image sensor 106 and the image stabilization lens 102. In addition to the movable ranges of these correction members, the correction ratio may also be determined taking into consideration the movable range of correction by cropping in image processing (electronic image stabilization).

A correction ratio multiplication unit 1334 multiplies the shake correction amount by the calculation result of the correction ratio calculation unit 1333, and obtains the final shake correction amount based on the correction ratio.

A position control unit 1335 performs PID control (proportional control, integral control, and differential control) on the deviation between the current position of the image sensor 106 and a target position of the image sensor 106 determined based on the shake correction amount, converts the difference into an image sensor shift signal, and outputs it to the image sensor shifting unit 130. The current position is the output result of the image sensor position detection unit 132. Since PID control is a common technique, a detailed description thereof will be omitted. The image sensor shifting unit 130 shifts the image sensor 106 in accordance with the image sensor shift signal.

An electronic image stabilization setting unit 1337 and an electronic image stabilization amount calculation unit 1336 realize electronic image stabilization, that is, image stabilization by cropping an area smaller than the angle of view of a captured image by image processing while controlling cropping position according to the direction and magnitude of the image blur.

The electronic image stabilization setting unit 1337 accepts settings for electronic image stabilization by the user from the operation unit 114. In this embodiment, a plurality of electronic image stabilization modes of different effectiveness are provided, and the size of the cropping range (for example, 60%, 80%, etc. of the entire imaging area) differs depending on the mode. Here, the effectiveness can be selected by selecting whether or not to perform electronic image stabilization and by selecting one of the plurality of electronic image stabilization modes, and the size of the cropping range with respect to the angle of view of a captured image is determined depending on the selection.

The electronic image stabilization amount calculation unit 1336 calculates an electronic image stabilization amount corresponding to the shake detection on the camera body 1 side calculated by the correction ratio calculation unit 1333 in accordance with the size of the cropping range calculated by the electronic image stabilization setting unit 1337. Using the electronic image stabilization amount calculated by the electronic image stabilization amount calculation unit 1336 as an input, the image processing circuit 109 performs electronic image stabilization by cropping an image of the set cropping range at predetermined coordinates from a captured image.

Next, a description will be given of the lens side image stabilization control unit 126 on the lens unit 2 side. Note that, in order to simplify the description, the description will be given assuming that the shake detection signal detected by the camera side shake detection unit 134 is not used.

A lens side integration unit 1261 integrates the angular velocity of shake detected by the lens side shake detection unit 125 thereby converting the angular velocity of shake into an angle of shake. Here, an integral LPF is used as the lens side integration unit 1261.

A shake correction amount calculation unit 1262 calculates a shake correction amount for canceling the angle of shake, taking into consideration the frequency band of the angle of shake and the movable range of the image stabilization lens 102. Specifically, the shake correction amount is calculated by multiplying a gain related to the zoom magnification and the subject distance to the angle of shake.

A correction ratio calculation unit 1263 obtains a shake correction amount based on a correction ratio by multiplying the correction ratio that is taken by the lens unit 2 side in a case where the sum of the shake correction amounts taken on the camera body 1 side and the lens unit 2 side is 100%. In this embodiment, the correction ratio that the lens unit 2 side takes is obtained from the calculation result of the correction ratio calculation unit 1333 provided on the camera body 1 side. The correction ratio that the lens unit 2 side takes is notified via the camera side communication unit 140 and the lens side communication unit 128.

A position control unit 1264 performs PID control (proportional control, integral control, and differential control) on the deviation between the current position of the image stabilization lens 102 and the target position of the image stabilization lens 102 determined based on the shake correction amount, converts the deviation into a lens shift signal, and outputs it to the image stabilization lens shifting unit 122. The current position is the output result of the image stabilization lens position detection unit 123. Since PID control is a common technique, a detailed description thereof will be omitted. The image stabilization lens shifting unit 122 shifts the image stabilization lens 102 in accordance with the lens shift signal.

In this manner, by shifting the image stabilization lens 102 and the image sensor 106 and by changing the cropping range of the image, image blur caused by camera shake can be reduced.

Next, the subject tracking calculation unit 142 on the camera body 1 side will be described.

In this embodiment, as described above, the subject tracking calculation unit 142 can change the position of the cropping range in the image based on the subject detection information obtained from the subject detection unit 141. The subject identification unit 143 can set any subject in the captured image as the main subject. The subject detection unit 141 obtains information such as position, size, and type of subject related to an arbitrary subject set by the subject identification unit 143.

A subject target position calculation unit 1424 accepts a target position where the subject is to be kept in the image. The target position may be, for example, the center of the screen, a position on the screen touched by the user on the operation unit 114, or a coordinate position stored in advance. In this embodiment, for the sake of simplicity, the center of the screen is set as the subject target position.

A tracking control amount calculation unit 1423 calculates a tracking control amount according to the target position set by the subject target position calculation unit 1424 and the position of the subject detected by the subject detection unit 141. The tracking control amount calculated by the tracking control amount calculation unit 1423 is input to the image processing circuit 109, which performs image processing, and in this embodiment, performs geometric conversion processing similar to electronic image stabilization. In this manner, subject tracking processing is performed.

A cropping size change determination unit 1425 determines whether or not the size of the cropping range to be cropped from the captured image by the image processing circuit 109 is to be changed based on various user settings set via the operation unit 114.

A display mode determination unit 1426 determines, based on various user settings set in the operation unit 114, whether the display unit 111 is in a state where a captured image is being displayed, or in a menu display state where only setting menu information is being displayed, as will be described below.

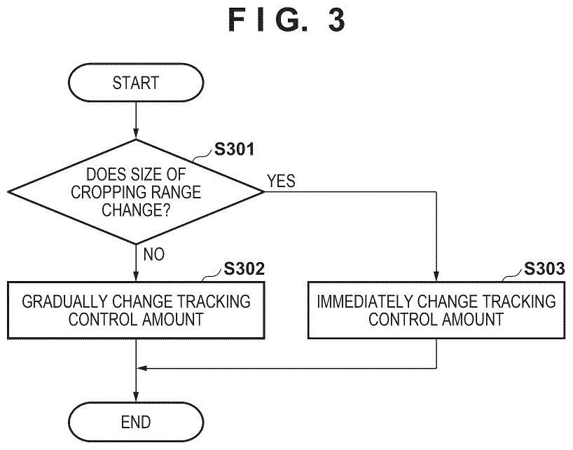

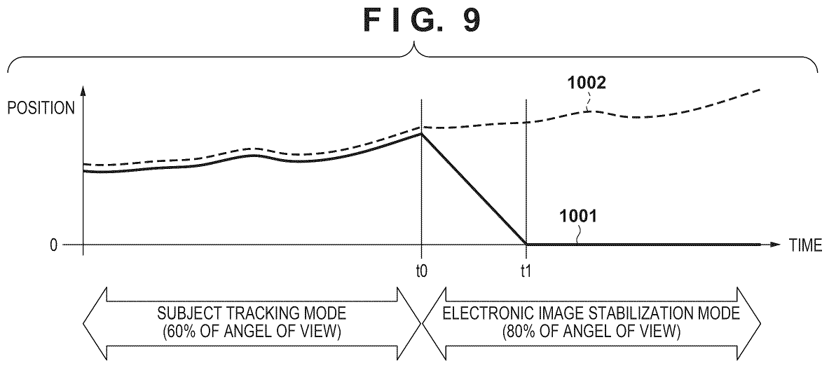

Next, the control procedure in this embodiment will be described with reference to the flowchart in FIG. 3. Here, the mode change between the subject tracking mode and the electronic image stabilization mode will be described. Even if the cropping range of the image by electronic image stabilization is gradually changed, if the size of the cropping range of the image changes depending on whether subject tracking is performed or not, incongruity may occur on the display screen at the time of starting or ending subject tracking. This problem will be described with reference to FIG. 9.

FIG. 9 is a schematic timing chart showing the change of the position of a cropping range of an image over time when changing from the subject tracking mode to the electronic image stabilization mode at time t0. In a period of the subject tracking mode, the position of the cropping range of the image (for example, the center position of the cropping range of the image) shown by a solid line 1001 moves to follow the tracking target position shown by a dashed line 1002, so that the subject stays at a predetermined position in the cropped image (for example, the center position of the image). When transitioning from the subject tracking mode to the electronic image stabilization mode with a different cropping size of the image at time t0, in order to avoid a sudden change in the position of the cropping range of the image, the tracking control amount gradually transitions to 0 (center position) from time t0 to t1. However, in this example, the size of the cropping range of the image also changes from 60% to 80% of the angle of view of the image at time t0. In general, the size of the cropping range of the image is often changed immediately. Therefore, the appearance of the display screen is such that, after a sudden change in the size of the cropping range of the image at time t0, the position of the cropping range of the image continues to move gradually toward the center of the angle of view of the image from time t0 to t1. Accordingly, the combination of the two changes causes a significant sense of incongruity. In consideration of the above, by changing the mode between the subject tracking mode and the electronic image stabilization mode as shown in FIG. 3, the change in the displayed image can be made less noticeable in a case where the mode change involves a change in the size and/or position of the cropping range of the image.

When a mode change request by a user is received from the operation unit 114, in step S301, the cropping size change determination unit 1425 determines whether the size of the cropping range changes before and after the mode change. Here, whether or not the size of the cropping range changes is determined by comparing the size of the cropping range in the subject tracking mode with the size of the cropping range for image stabilization set in the electronic image stabilization setting unit 1337. If it is determined that the size of the cropping range does not change, the process proceeds to step S302, where the tracking control amount calculation unit 1423 controls the tracking control amount so that the position of the cropping range gradually transitions to a target position after the mode change over a predetermined time. On the other hand, if it is determined that the size of the cropping range will change, the process proceeds to step S303, where the tracking control amount is controlled so that the position of the cropping range changes immediately.

The control in steps S302 and S303 will be described in detail below.

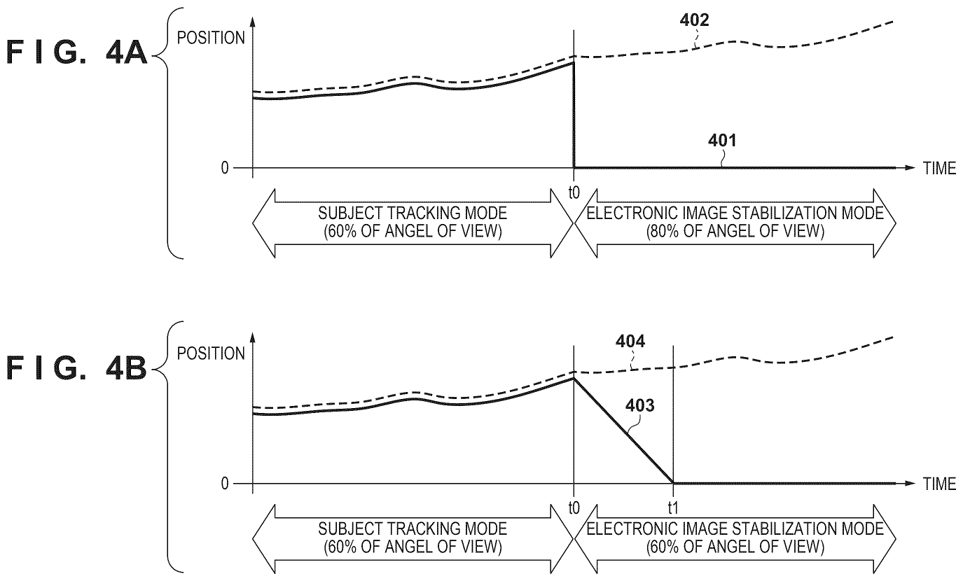

FIGS. 4A and 4B are time charts showing specific examples of change in the tracking control amount over time in a case where the subject tracking mode is changed to the electronic image stabilization mode, in which solid lines 401 and 403 represent the tracking control amount and dashed lines 402 and 404 represent the tracking target position.

FIG. 4A shows an example of a case where the size of the cropping range changes before and after the mode change, and at time t0, the mode is changed from a subject tracking mode in which the size of the cropping range is 60% of the angle of view to an electronic image stabilization mode in which the size of the cropping range is 80% of the angle of view. In the subject tracking mode, as shown by the tracking control amount 401, tracking control is realized to keep the detected subject at a target position in a cropped partial image so that the subject is located at a tracking target position 402. When the subject tracking mode ends at time t0, the tracking control amount is immediately changed to 0, and the position of the cropping range is transitioned to the initial position (center) at the same time as the size of the cropping range is changed. In this way, by simultaneously and immediately changing the size of the cropping range and the position of the cropping range, it is possible to reduce the discomfort felt by the change in size and the change in position of the cropping range occurring stepwise at different timings, as described above with reference to FIG. 9.

FIG. 4B shows an example of a case where the size of the cropping range does not change before and after the mode change, and at time t0, the mode is changed from a subject tracking mode in which the size of the cropping range is 60% of the angle of view to an electronic image stabilization mode in which the size of the cropping range is also 60% of the angle of view. When the subject tracking mode ends at time t0 as in FIG. 4A, the tracking control amount is gradually transitioned to 0 over time until time t1, and the position of the cropping range is gradually transitioned to the initial position (center). In this way, in a case where the size of the cropping range does not change, the position of the cropping range is gradually transitioned, thereby improving the discomfort felt by the user when viewing the display screen.

In the examples shown in FIGS. 4A and 4B, cases where the subject tracking mode is changed to the electronic image stabilization mode is described, but the present invention is not limited to this, and may be applied, for example, to a case where the electronic image stabilization mode is changed to the subject control mode. The size of the cropping range is also an example, and is not limited to them.

Furthermore, the present invention may also be applied to a case where a mode can be selected from modes in which the sizes or positions of the cropping range differ depending on the strength of the subject tracking or image stabilization in the subject tracking mode and the electronic image stabilization mode. In that case, in a case where only the size of the cropping range changes, the size may be changed gradually instead of the position. In other words, whether the cropping range is changed immediately or gradually can be controlled depending on whether the size and/or position of the cropping range are/is changed.

As described above, according to the first embodiment, in a case where a mode change involves a change in the size and/or position of the cropping range of an image, the change in the displayed image can be made less noticeable.

### Second Embodiment

Next, a second embodiment of the present invention will be described.

In the first embodiment, a case where a tracking control amount is controlled according to the size of the cropping range at the time of switching between the subject tracking mode and the electronic image stabilization mode is described. In contrast, in the second embodiment, a case where a tracking control amount is further controlled according to a display mode when a user instructs switching between the subject tracking mode and the electronic image stabilization mode will be described. Note that the configuration of the image capturing apparatus in the second embodiment is the same as that described with reference to FIGS. 1 and 2 in the first embodiment, so a description thereof will be omitted here.

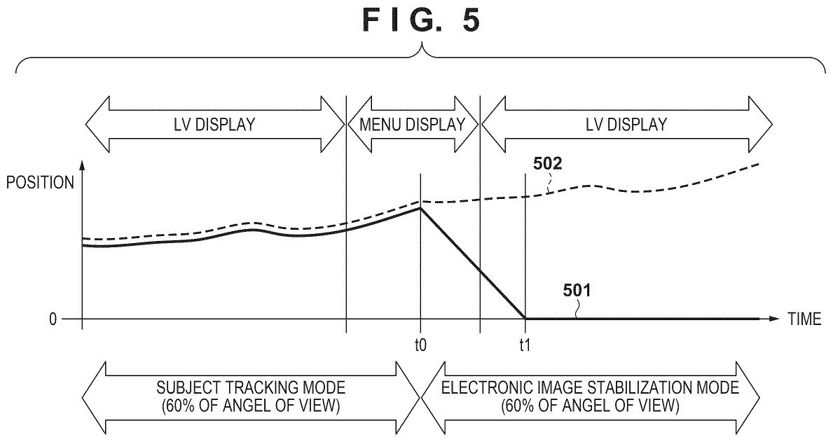

In this embodiment, there are two display modes: a live view (LV) display in which a captured image is always displayed on the display unit 111, and a state in which the LV display is interrupted and only setting menu information is displayed on the display unit 111 (hereinafter referred to as “menu display”). Here, if the same control as in the first embodiment is performed when changing from the subject tracking mode to the electronic image stabilization mode during menu display, for example, a problem different from that in the first embodiment may occur. The problem will be described with reference to FIG. 5.

FIG. 5 shows an example of a change in the tracking control amount over time, similar to FIG. 4B, where a solid line 501 indicates the tracking control amount and a dashed line 502 indicates the tracking target position. Here, a case is shown in which the display screen is in a menu display state when a mode change is performed at time t0. Here, if the size of the cropping range in the subject tracking mode and the electronic image stabilization mode is the same (e.g., 60%), since the mode change is not accompanied with the change in the size of the cropping range, if the tracking control amount is gradually transitioned as described in the first embodiment, there may be a case where the transition of the image cropping position continues from the time at which the menu display changes to the LV display to time t1, and the LV display may look unnatural.

Accordingly, in the second embodiment, when the mode is changed during the menu is displayed, the tracking control amount is immediately changed to 0 regardless of whether the size of the cropping range will be changed or not.

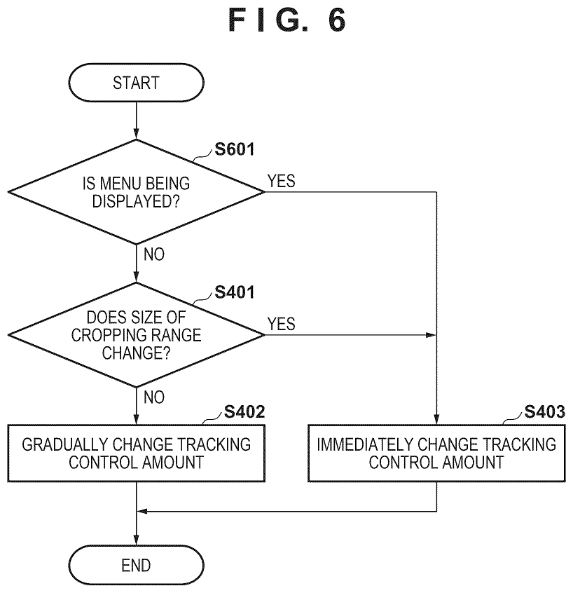

FIG. 6 is a flowchart illustrating the control in the second embodiment.

When a user's mode change request is received from the operation unit 114, in step S601, the display mode determination unit 1426 determines whether or not the display unit 111 is displaying a menu. If it is determined that the menu is being displayed, the process proceeds to step S303, where the tracking control amount is immediately changed regardless of whether or not the size of the cropping range will change.

On the other hand, if it is determined in step S601 that the display unit 111 is not displaying a menu, in steps S301 to S303, the tracking control amount is controlled based on whether or not the size of the cropping range will change, as in the first embodiment described above.

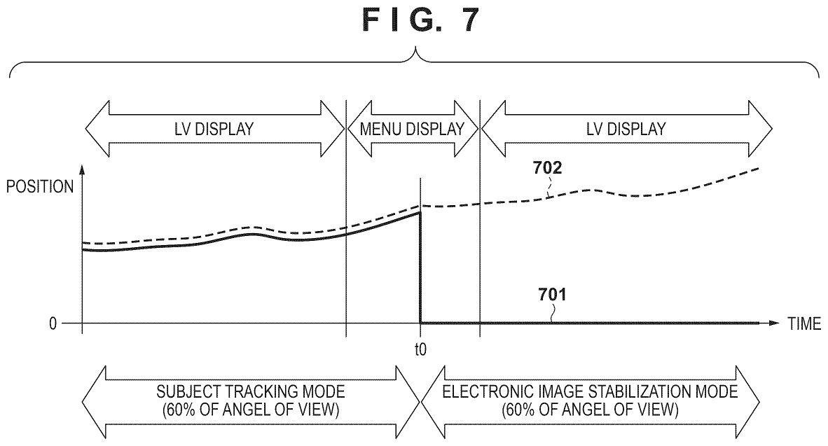

FIG. 7 is a time chart showing a change in the tracking control amount in a case where it is determined that the display unit 111 is in the menu display state in the second embodiment. An example is shown in which, at time t0, the subject tracking mode with the size of a cropping range of 60% of an angle of view is changed to the electronic image stabilization mode with the size of a cropping range of 60% of the angle of view. A solid line 701 represents the tracking control amount, and a dashed line 702 represents the tracking target position. As shown in FIG. 7, at time t0, the subject tracking mode is changed to the electronic image stabilization mode, and the tracking control amount is immediately changed to 0.

This makes it possible to avoid a phenomenon in which the screen transition remains when returning from the menu display state to the LV display. Also, since the menu is being displayed, there is no visual discomfort caused by the immediate transition of the position of the cropping range.

In the above example, the amount of tracking control is controlled depending on whether the display unit 111 is in a menu display state. However, this is not limited to menu display, and the position of a cropping range in an image may be immediately changed when LV display is not being performed.

As described above, according to the second embodiment, changes in the displayed image can be made less noticeable.

### Third Embodiment

Next, a third embodiment of the present invention will be described.

In the first and second embodiments, in a case where the size of the cropping range will change, the tracking control amount is always immediately changed, however, some users may feel uncomfortable with this sudden change in LV display. Therefore, in this embodiment, both the size of the cropping range and the tracking control amount are transitioned gradually. Note that the configuration of the image capturing apparatus in the third embodiment is the same as that described with reference to FIGS. 1 and 2 in the first embodiment, so a description thereof will be omitted here.

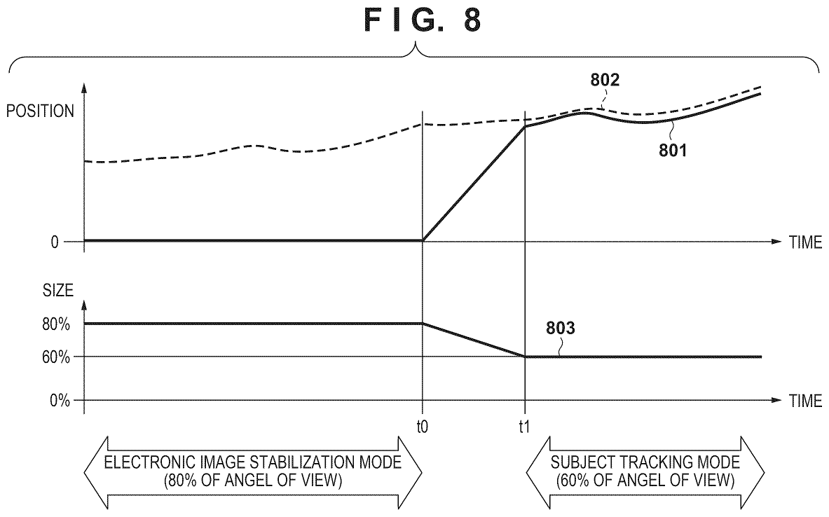

The control in this embodiment will be described below with reference to FIG. 8.

In FIG. 8, a solid line 801 represents the tracking control amount, a dashed line 802 represents the tracking target position, and a solid line 803 represents the size of a cropping range. At time t0, when a user instructs to change from an electronic image stabilization mode in which the size of the cropping range is 80% of an angle of view to a subject tracking mode in which the size of the cropping range size is 60% of the angle of view, in this embodiment, both the size of the cropping range and the tracking control amount gradually transition from time t0 to t1. By gradually transitioning both the size and position of the cropping range in this way, it is possible to avoid the discomfort that occurs when the screen changes abruptly.

However, in the case of the above-mentioned control, it is preferable to perform processing such that the tracking control amount transitions gradually so that the cropping range is kept within the imaging range, for example, by setting a limiter for the tracking control amount as the size of the image changes.

In FIG. 8, the case where the size of the cropping range is reduced as the setting changes has been described as an example, but the present invention is not limited to this. Conversely, the same control may be used when the size of the cropping range is increased. Alternatively, different control may be performed when the size of the cropping range is reduced and when the size of the cropping range is increased. For example, in a case where the size of the cropping range is increased, the position of the cropping range is changed more abruptly (changed in a shorter time) than in a case where the size of the cropping range is decreased. When the size of the cropping range is increased and the angle of view becomes wider, the change in the position of the cropping range is less noticeable than when the size of the cropping range is decreased. Therefore, even if the position of the cropping range is changed abruptly, it can be changed to the desired position quickly with less discomfort. Alternatively, in a case where the size of the cropping range is changed to be smaller, the position of the cropping range is changed more abruptly than in a case where the size of the cropping range is changed to be larger. When the size of the cropping range is changed to a smaller size, since the image is zoomed in and the position intended by the photographer is more likely to deviate from the cropping range than when the size of the cropping range is changed to a larger size. Therefore, by changing the position of the cropping range abruptly, it is possible to prevent the position intended by a photographer from deviating from the cropping range.

As described above, according to the third embodiment, when a mode change involves a change in the size and/or position of the cropping range of an image, the change in the displayed image can be made less noticeable.

The first and third embodiments are common in that, in a case where the size of the cropping range changes before and after the mode change, the position of the cropping range is changed in a shorter time than in a case where the size of the cropping range does not change before and after the mode change. For example, assume that a mode change to the electronic image stabilization mode occurs in a state where a subject performing a predetermined specific movement is tracked in the subject tracking mode. Here, the position of the cropping range before the mode change is set to a first position, and the target position of the cropping range after the mode change is set to a second position. Then, the time required to change the position of the cropping range from the first position to the second position is made different depending on whether or not the size of the cropping range changes before and after the mode change. More specifically, in a case where the size of the cropping range changes, the time required to change the position of the cropping range from the first position to the second position is made shorter than in a case where the size of the cropping range does not change. It should be noted that shortening the time required to change the position of the cropping range from the first position to the second position corresponds to increasing the amount of change in the position of the cropping range between successive frames.

### Other Embodiment

The present invention may be applied to a system made up of a plurality of devices, or to an apparatus made up of a single device.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-054632, filed Mar. 28, 2024 which is hereby incorporated by reference herein in its entirety.

What is claimed is:

1. An image processing apparatus comprising one or more processors and/or circuitry which function as:
an input unit that inputs an image;
a processing unit that crops a partial image of a predetermined range from the image;
a control unit that controls size and position of the range; and
a switching unit that switches between a plurality of modes involving processing of cropping the partial image,
wherein in a case where at least one of the size and the position of the range changes before and after the switching of the mode by the switching unit, the control unit controls to gradually change the size and/or the position of the range that changes before and after the switching of the mode.

2. The image processing apparatus according to claim 1, wherein the control unit performs a first control in which, in a case where the size and the position of the range change before and after the switching of the mode by the switching unit, the control unit immediately changes the size and the position of the range, and, in a case where either the size or the position of the range changes before and after the switching of the mode, the control unit gradually changes the size or the position of the range that changes before and after the switching of the mode.

3. The image processing apparatus according to claim 2, wherein the one or more processors and/or circuitry further functions as a selection unit that selects one of a plurality of display modes including a first display mode in which the partial image is displayed on a display unit and a second display mode in which the partial image is not displayed on the display unit,
wherein the control unit
performs the first control in a case where the first display mode is selected, and
performs a second control in a case where the second display mode is selected, in which the control unit immediately changes the size and the position of the range regardless of whether the size and the position of the range change before and after the switching of mode by the switching unit.

4. The image processing apparatus according to claim 1, wherein the one or more processors and/or circuitry further functions as:
an acquiring unit that acquires an amount of shake from a detection unit; and
a subject detection unit that detects a predetermined subject from the image,
wherein the plurality of modes include a first mode in which the position of the range is moved based on the amount of shake, and a second mode in which the position of the range is moved based on a position of the subject, and
wherein the control unit controls the size and the position of the range in a case where switching between the first mode and the second mode.

5. The image processing apparatus according to claim 4, wherein the first mode is a mode for performing image stabilization, and the second mode is a mode for tracking a subject.

6. The image processing apparatus according to claim 4, wherein the one or more processors and/or circuitry further functions as a setting unit that sets the subject.

7. The image processing apparatus according to claim 4, wherein the detection unit detects the amount of shake based on a motion vector between the images inputted successively.

8. The image processing apparatus according to claim 4, wherein the detection unit includes a gyro sensor.

9. An image processing apparatus comprising one or more processors and/or circuitry which function as:
an input unit that inputs an image;
a processing unit that crops a partial image of a predetermined range from the image;
a control unit that controls size and position of the range; and
a switching unit that switches between a plurality of modes involving processing of cropping the partial image,
wherein, in a case where the size of the range changes before and after the switching of the mode by the switching unit, the control unit changes the position of the range in a shorter time than in a case where the size of the range does not change before and after the switching of the mode.

10. The image processing apparatus according to claim 9, wherein the one or more processors and/or circuitry further functions as:
an acquiring unit that acquires an amount of shake from a detection unit; and
a subject detection unit that detects a predetermined subject from the image,
wherein the plurality of modes include a first mode in which the position of the range is moved based on the amount of shake, and a second mode in which the position of the range is moved based on a position of the subject, and
wherein the control unit controls the size and the position of the range in a case where switching between the first mode and the second mode.

11. The image processing apparatus according to claim 10, wherein the first mode is a mode for performing image stabilization, and the second mode is a mode for tracking a subject.

12. The image processing apparatus according to claim 10, wherein the one or more processors and/or circuitry further functions as a setting unit that sets the subject.

13. The image processing apparatus according to claim 10, wherein the detection unit detects the amount of shake based on a motion vector between the images inputted successively.

14. The image processing apparatus according to claim 10, wherein the detection unit includes a gyro sensor.

15. An electronic apparatus comprising:
an image processing apparatus comprising one or more processors and/or circuitry which function as:
an input unit that inputs an image;
a processing unit that crops a partial image of a predetermined range from the image;
a control unit that controls size and position of the range; and
a switching unit that switches between a plurality of modes involving processing of cropping the partial image; and
an image sensor that shoots an image,
wherein in a case where at least one of the size and the position of the range changes due to the switching of the modes by the switching unit, the control unit controls so that the size and/or the position of the range that changes gradually changes.

16. An electronic apparatus comprising:
an image processing apparatus comprising one or more processors and/or circuitry which function as:
an input unit that inputs an image;
a processing unit that crops a partial image of a predetermined range from the image;
a control unit that controls size and position of the range; and
a switching unit that switches between a plurality of modes involving processing of cropping the partial image; and
an image sensor that shoots an image,
wherein, in a case where the size of the range changes before and after a mode change due to the switching of the mode by the switching unit, the control unit changes the position of the range in a shorter time than in a case where the size of the range does not change before and after the mode change.

17. An image processing method for cropping a partial image of a predetermined range from an input image comprising:
determining whether or not switching between a plurality of modes involving processing of cropping the partial image is performed; and
in a case where it is determined that the mode is switched and at least one of the size and the position of the range changes before and after the switching of the mode, gradually changing the size and/or the position of the range that changes before and after the switching of the mode.

18. An image processing method for cropping a partial image of a predetermined range from an input image comprising:
determining whether or not switching between a plurality of modes involving processing of cropping the partial image is performed; and
in a case where it is determined that the mode is switched and the size of the range changes before and after the switching of the mode, changing the position of the range in a shorter time than in a case where the size of the range does not change before and after the switching of the mode.

19. A non-transitory computer-readable storage medium, the storage medium storing a program that is executable by the computer, wherein the program includes program code for causing the computer to function as an image processing apparatus comprising:
an input unit that inputs an image;
a processing unit that crops a partial image of a predetermined range from the image;
a control unit that controls size and position of the range; and
a switching unit that switches between a plurality of modes involving processing of cropping the partial image,
wherein in a case where at least one of the size and the position of the range changes before and after the switching of the mode by the switching unit, the control unit controls to gradually change the size and/or the position of the range that changes before and after the switching of the mode.

20. A non-transitory computer-readable storage medium, the storage medium storing a program that is executable by the computer, wherein the program includes program code for causing the computer to function as an image processing apparatus comprising:
an input unit that inputs an image;
a processing unit that crops a partial image of a predetermined range from the image;
a control unit that controls size and position of the range; and
a switching unit that switches between a plurality of modes involving processing of cropping the partial image,
wherein, in a case where the size of the range changes before and after the switching of the mode by the switching unit, the control unit changes the position of the range in a shorter time than in a case where the size of the range does not change before and after the switching of the mode.
